(19) United States
(12) Patent Application Publication
(10) Pub. No.: US 2014/0326631 A1
(43) Pub. Date: Nov. 6, 2014

(54) SHIPPING CONTAINERS WITH STACKING TABS AND METHODS FOR MAKING THE SAME

(71) Applicant: Rock-Tenn Shared Services, LLC, Norcross, GA (US)

(72) Inventors: John W. Cotie, Amherstburg (CA); Kenneth John Shanton, West Chicago, IL (US)

(21) Appl. No.: 14/267,509

(22) Filed: May 1, 2014

Related U.S. Application Data
(60) Provisional application No. 61/818,818, filed on May 2, 2013.

(51) Int. Cl. B65D 5/00; B31B 1/74; B65D 5/20; B65D 5/42; B65D 21/02

(52) U.S. Cl. CPC B65D 5/005; B65D 5/42; B65D 21/0212; B65D 5/20; B31B 1/74
USPC 206/509; 229/187; 229/182.1; 206/557; 493/84

(57) ABSTRACT

A blank of sheet material for forming a polygonal container is provided. The blank includes a bottom panel, two opposing end panels each extending from opposing end edges of the bottom panel, two opposing side panels each extending from opposing side edges of the bottom panel, and interior end panels foldably connected to each side edge of each side panel along a first fold line. The bottom panel includes a plurality of slots configured to receive stacking tabs of a formed container. Each side panel includes at least one stacking tab extending from a top edge of the side panel. Each interior end panel includes at least one stacking tab extending from a first edge of the respective interior end panel.

### BACKGROUND OF THE DISCLOSURE

This patent application claims priority to U.S. Provisional Patent Application Ser. No. 61/818,818, filed on May 2, 2013, which is hereby incorporated by reference in its entirety.

The embodiments described herein relate generally to a blank for forming a container and, more particularly, to a blank for forming a shipping container having multiple stacking tabs disposed on side panels and interior end panels.

Containers are frequently utilized to store and aid in transporting products. These containers can be square, hexagonal, or octagonal. Some of these containers are referred to as shipping trays because they are used to ship or transport products for eventual sale. In at least some known cases, a blank of sheet material is used to form a container or tray for transporting a product. Such containers may have certain strength requirements for transporting products. These strength requirements may include a stacking strength requirement such that the containers can be stacked on one another during transport without collapsing. To meet these strength requirements, at least some known containers include rollover panels placed in a face-to-face relationship with a side panel or side wall for providing additional stacking strength. However, the rollover panels increase the overall width of the blank compared to blanks without rollover panels. As such, the footprint of such blanks is larger than blanks without rollover panels, and the rate at which such blanks can be manufactured (i.e., throughput) is reduced.

### BRIEF DESCRIPTION OF THE DISCLOSURE

In one aspect, a blank of sheet material for forming a polygonal container is provided. The blank includes a bottom panel, two opposing end panels each extending from opposing end edges of the bottom panel, two opposing side panels each extending from opposing side edges of the bottom panel, and interior end panels foldably connected to each side edge of each side panel along a first fold line. The bottom panel includes a plurality of slots configured to receive stacking tabs of a formed container. Each side panel includes at least one stacking tab extending from a top edge of the side panel. Each interior end panel includes at least one stacking tab extending from a first edge of the respective interior end panel.

In another aspect, a polygonal container formed from a blank of sheet material is provided. The container includes a bottom wall, a pair of opposing end walls coupled to the bottom wall, and a pair of opposing side walls coupled to the bottom wall. Each end wall includes at least one stacking tab extending from a top edge of the respective end wall. Each side wall includes at least one stacking tab extending from a top edge of the side wall.

In yet another aspect, a method of forming a polygonal container from a blank of sheet material is provided. The blank includes a bottom panel, two opposing end panels each extending from opposing end edges of the bottom panel, two opposing side panels each extending from opposing side edges of the bottom panel, and interior end panels foldably connected to each side edge of each side panel along a first fold line. Each side panel of the blank includes at least one stacking tab extending from a top edge of the side panel, and each interior end panel of the blank includes at least one stacking tab extending from a first edge of the respective interior end panel. The method includes rotating each side panel towards an interior surface of the bottom panel such that each side panel forms an angle of less than about 90 degrees with respect to the bottom panel, wherein the side panels define opposing side walls, rotating each interior end panel about the first fold line such that each interior end panel is substantially perpendicular to a respective side panel, rotating each end panel towards an exterior surface of the interior end panels such that each end panel forms an angle of less than about 90 degrees with respect to the bottom panel, and coupling each end panel to the exterior surfaces of two interior end panels to form two opposing end walls.

In yet another embodiment, a shipping system for a polygonal container formed from a blank of sheet material is provided. The shipping system includes at least one container that has a bottom wall and a pair of opposing end walls coupled to the bottom wall. Each end wall includes at least one stacking tab extending from a top edge of the respective end wall. The at least one container also includes a pair of opposing side walls coupled to the bottom wall. Each side wall includes at least one stacking tab extending from a top edge of the side wall. The shipping system also includes a shipping hood that has a top wall, a pair of opposing end walls coupled to the top wall at a respective pair of end edges, a pair of opposing side walls coupled to the top wall at a pair of respective side edges, and a cavity defined by the pair of opposing end walls, the pair of opposing side walls, and the top wall. The cavity is configured to receive the at least one container. The top wall includes at least one slot adjacent each of the pair of end edges and configured to receive the at least one stacking tab that extends from the top edge of the respective end wall of the at least one container. The top wall also includes at least one slot adjacent each of the pair of side edges and configured to receive the at least one stacking tab that extends from the top edge of the respective side wall.

### BRIEF DESCRIPTION OF THE DRAWINGS

FIGS. 1-3, 5-6, 8 and 10-14 show example embodiments of the blanks and containers described herein.

FIG. 1 is a top plan view of an example blank of sheet material for forming a container in accordance with the present disclosure.

FIG. 2 is a perspective view of an example container formed from the blank shown in FIG. 1.

FIG. 3 is a perspective view of a stack of containers shown in FIG. 2.

FIG. 4 is a top plan view of a conventional blank of sheet material for forming a conventional container having a rollover panel and a gusset panel.

FIG. 5 is a cross-sectional view of a sheet of double-wall corrugated paperboard as used in the blank shown in FIG. 1.

FIG. 6 is a schematic illustration of a corrugator machine used to make sheets of corrugated paperboard.

FIG. 7 is a schematic illustration of the corrugator machine of FIG. 6 showing a blank layout pattern for the conventional blank of FIG. 4.

FIG. 8 is a schematic illustration of the corrugator machine of FIG. 6 showing a blank layout pattern for the blank of FIG. 1.

FIG. 9 is a schematic illustration of the process of fabricating the conventional blanks of FIG. 4 from a corrugated sheet of material.

FIG. 10 is a schematic illustration of the process of fabricating the blanks of FIG. 1 from a double-wall corrugated sheet of material.

FIG. 11 is a top plan view of an alternative blank of sheet material for forming a container.

FIG. 12 is a perspective view of an example container formed from the blank shown in FIG. 11.

FIG. 13 is a perspective view of an example shipping hood that may be used with at least one of the containers shown in FIGS. 2 and 3.

FIG. 14 is a perspective view of an example shipping hood that may be used with at least one of the containers shown in FIG. 12.

### DETAILED DESCRIPTION OF THE DISCLOSURE

The embodiments described herein provide a stackable container formed from a blank of sheet material, and a method for constructing the container.

In one embodiment, the blanks are fabricated from a corrugated cardboard material. The blanks, however, may be fabricated using any suitable material, and therefore are not limited to a specific type of material. In alternative embodiments, the blanks are fabricated using cardboard, plastic, fiberboard, paperboard, foamboard, corrugated paper, and/or any suitable material known to those skilled in the art and guided by the teachings herein provided. The container may have any suitable size, shape, and/or configuration, whether such sizes, shapes, and/or configurations are described and/or illustrated herein. Further, different embodiments described herein can vary in size and/or dimensions although similar labels are used for each embodiment.

In an example embodiment, the container includes at least one marking thereon including, without limitation, indicia that communicates the product stored in the tray, a manufacturer of the product, and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to, ink jet printing, laser printing, screen printing, giclée, pen and ink, painting, offset lithography, flexography, relief print, rotogravure, dye transfer, and/or any suitable printing technique known to those skilled in the art and guided by the teachings herein provided. In another embodiment, the container is void of markings, such as, without limitation, indicia that communicates the product, a manufacturer of the product and/or a seller of the product.

The following detailed description illustrates the disclosure by way of example and not by way of limitation. The description clearly enables one skilled in the art to make and use an example container, describes several embodiments, adaptations, variations, alternatives, and use of the blanks and/or containers, including what is presently believed to be the best mode of carrying out the disclosure.

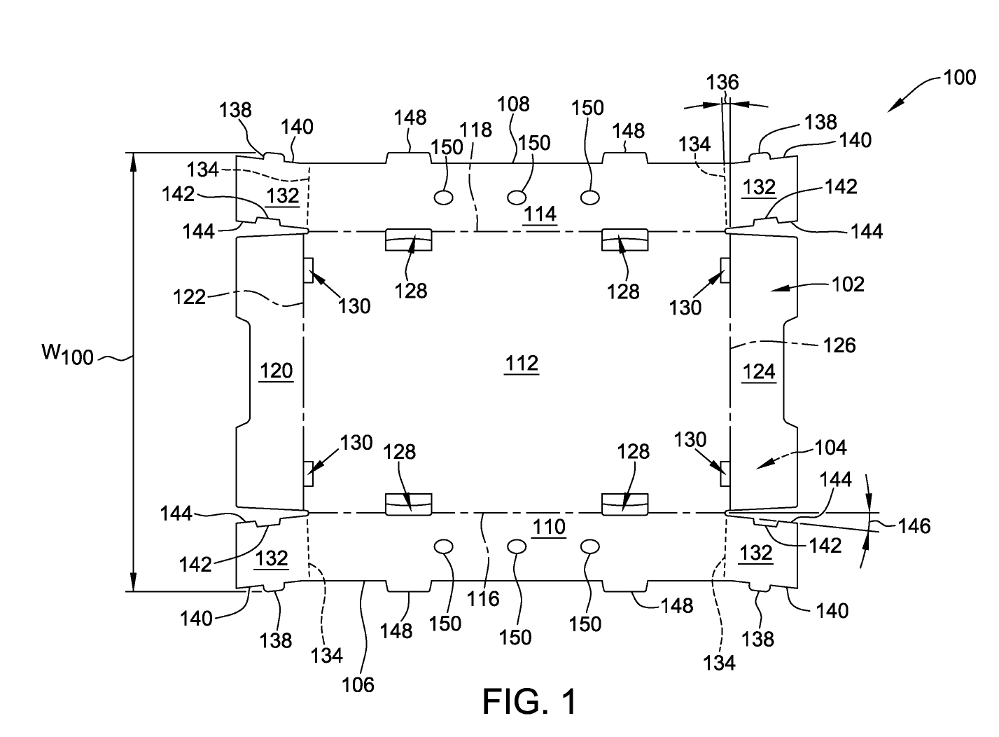

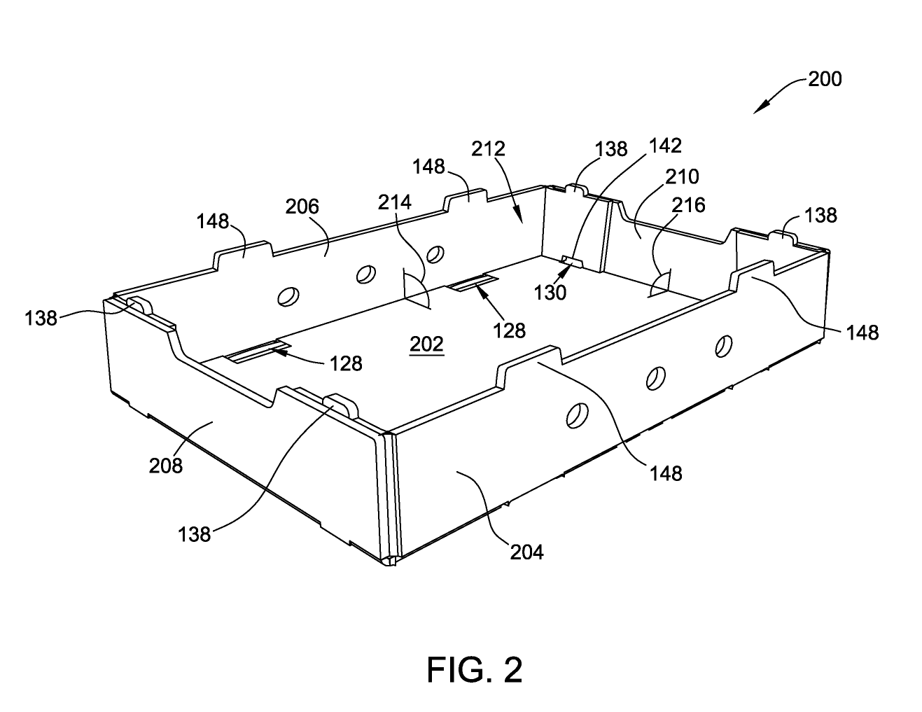

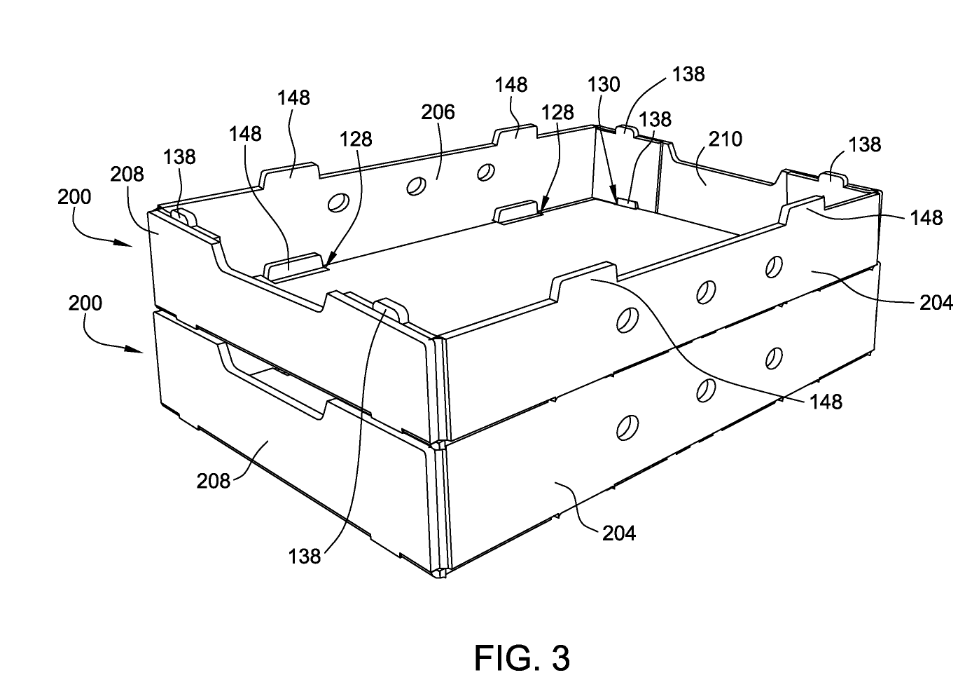

Referring now to the drawings, FIG. 1 is a top plan view of an example blank 100 of sheet material for forming a container 200 (shown in FIGS. 2 and 3). Blank 100 has a first or interior surface 102 and an opposing second or exterior surface 104. Blank 100 defines a first edge 106 and an opposing second edge 108. Blank 100 has a width W₁₀₀ defined by the outermost points along first and second edges 106 and 108. In one embodiment, blank 100 includes, in series from first edge 106 to second edge 108, a first side panel 110, a bottom panel 112, and a second side panel 114 coupled together along preformed, generally parallel, fold lines 116 and 118, respectively. A first end panel 120 extends from a first end edge of bottom panel 112 along a fold line 122, and an opposing second end panel 124 extends from a second end edge of bottom panel 112 along a fold line 126.

In the example embodiment, a pair of slots 128 is defined along each fold line 116 and 118. A pair of slots 130 is also defined along each fold line 122 and 126. Slots 128 and 130 are configured to receive a stacking tab from a lower container, as described in more detail below.

An interior end panel 132, also known as a glue panel, extends from each side edge of each side panel 110 and 114. As such, blank 100 includes four interior end panels 132. Each interior end panel 132 extends from a respective outer side panel 110 or 114 at a fold line 134. In one embodiment, each fold line 134 is tapered at an angle 136 of less than about five degrees, and, more specifically, between about zero degrees and about three degrees, and, even more specifically, about one degree with respect to fold lines 122 and 126. As a result, end walls 208 and 210 of formed container (shown in FIG. 2) are angled inwardly when blank is articulated to form container 200. As described in more detail below, the inward angle of end walls 208 and 210 facilitates stacking a plurality of containers 200 each formed from blank 100 (shown in FIG. 3). In an alternative embodiment, however, at least one fold line 134 is not tapered, such that angle 136 is zero.

Each interior end panel 132 includes at least one stacking tab 138 extending from a top edge 140 of the interior end panel 132, and at least one notch 142 extending into the interior end panel 132 from a bottom edge 144 opposite the top edge 140. Stacking tabs 138 are configured to be received in a slot 130 of a formed container 200 when in a stacked configuration (shown in FIG. 3). Notches 142 are configured to facilitate the insertion of stacking tabs 138 into slots of a formed container 200 when in a stacked configuration (shown in FIG. 3). In the example embodiment, each interior end panel 132 includes one stacking tab 138 and one notch 142.

In one embodiment, the bottom edge 144 of each interior end panel 132 is tapered at an angle 146 of less than about seven degrees, and, more specifically, between about one degree and about five degrees, and, even more specifically, about three degrees with respect to fold lines 116 and 118. As a result, side walls 204 and 206 of formed container 200 (shown in FIG. 2) are angled inwardly when blank 100 is articulated to form container 200. As described in more detail below, the inward angle of side walls 204 and 206 facilitates stacking a plurality of containers 200 each formed from blank 100 (shown in FIG. 3). In an alternative embodiment, however, the bottom edge 144 of at least one interior end panel 132 is not tapered, such that angle 146 is zero.

Side panel 110 includes two stacking tabs 148 extending from the first edge 106 of blank 100, and side panel 114 includes two stacking tabs 148 extending from the second edge 108 of blank 100. Thus, the blank 100 includes a total of eight stacking tabs 138 and 148. Each stacking tab 148 is configured to be received in one of the slots 128 of a formed container 200 when in a stacked configuration (shown in FIG. 3). The stacking tabs 148 on opposing side panels define the width W₁₀₀ of blank 100. In the example embodiment, blank 100 has a width W₁₀₀ of about 24 inches or 609 mm. Side panels 110 and 114 may also include vent holes 150.

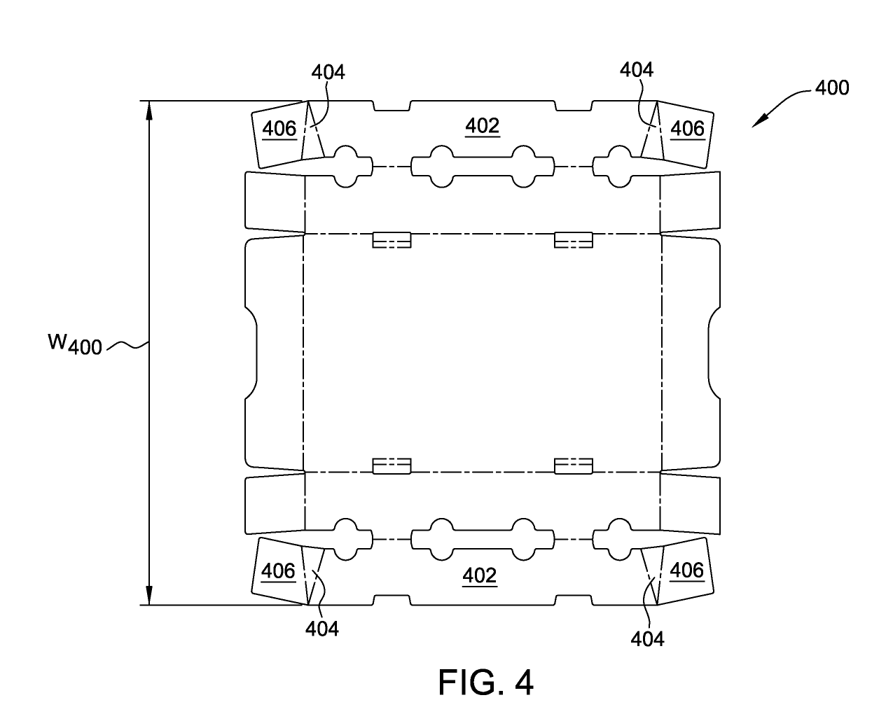

Although specific dimensions are provided herein, blank 100 is not limited to these specific dimensions. Rather, dimensions are provided to illustrate how the overall footprint of blank 100 used to form container 200 is less than the conventional blank 400 (shown in FIG. 4) used to form a similarly dimensioned container.

FIG. 2 is a perspective view of an example container 200 formed from blank 100 (shown in FIG. 1). Container 200 includes a bottom wall 202, first and second opposing side walls 204 and 206, and first and second opposing end walls 208 and 210. Side walls 204 and 206 and end walls 208 and 210 define a cavity 212. Slots 128 and 130 are at least partially defined in bottom wall 202. Each slot 128 is adjacent to one of the side walls 204 and 206. Each slot 130 is adjacent to one of the end walls 208 and 210. Each notch 142 of the interior end panels 132 is aligned with one slot 130 adjacent the respective end wall 208 or 210. Each side wall 204 and 206 includes two stacking tabs 148, and each end wall 208 and 210 includes two stacking tabs 138. Thus, the container 200 includes a total of 8 stacking tabs 138 and 148.

In one embodiment, each side wall 204 and 206 forms an angle 214 of less than about 90 degrees with respect to the bottom wall 202. More specifically, each side wall 204 and 206 forms an angle 214 of between about 85 degrees and about 89 degrees and, even more specifically, about 87 degrees with respect to bottom wall 202. In an alternative embodiment, however, at least one of side walls 204 and 206 forms an angle 214 of about 90 degrees.

In one embodiment, each end wall 208 and 210 forms an angle 216 of less than about 90 degrees with respect to the bottom wall 202. More specifically, each end wall 208 and 210 forms an angle of between about 87 degrees and about 90 degrees and, even more specifically, about 89 degrees with respect to the bottom wall 202. In an alternative embodiment, however, at least one of end walls 208 and 210 forms an angle 216 of about 90 degrees with respect to the bottom wall 202.

The container 200 is formed by folding blank 100 along fold lines. Specifically, the first side wall 204 of container 200 is formed by rotating first side panel 110 about fold line 116 toward an interior surface 102 of bottom panel 112. Second side wall 206 is formed by rotating second side panel 114 about fold line 118 toward an interior surface 102 of bottom panel 112. In one embodiment, first and second side panels 110 and 114 are rotated to form an angle of less than 90 degrees with respect to bottom panel 112. More specifically, first and second side panels 110 and 114 are rotated to form an angle of between about 85 degrees and about 89 degrees and, even more specifically, about 87 degrees with respect to bottom panel 112. In an alternative embodiment, however, at least one of first and second side panels 110 and 114 is rotated to form an angle of about 90 degrees with respect to bottom panel 112.

Each interior end panel 132 is rotated about fold line 134 such that each interior end panel 132 is substantially perpendicular to its respective side panel 110 or 114. First end panel 120 is rotated about fold line 122 towards an exterior surface 104 of interior end panels 132. First end panel 120 is coupled to two interior end panels 132 using an adhesive, such as glue, to form first end wall 208. Second end panel 124 is rotated about fold line 126 towards an exterior surface 104 of interior end panels 132. Second end panel 124 is coupled to two interior end panels 132 using an adhesive, such as glue, to form second end wall 210. In one embodiment, first and second end panels 120 and 124 are rotated to form an angle 216 of less than about 90 degrees with respect to bottom panel 112. More specifically, first and second end panels 120 and 124 are rotated to form an angle of between about 87 degrees and about 90 degrees and, even more specifically, about 89 degrees with respect to bottom panel 112. In an alternative embodiment, however, at least one of first and second end panels 120 and 124 is rotated to form an angle of about 90 degrees with respect to bottom panel 112.

FIG. 3 is a perspective view of a stack of containers 200. When containers 200 are stacked, stacking tabs 138 on end walls 208 and 210 of a lower container 200 are received within slots 130 of an upper container 200. Similarly, stacking tabs 148 on side walls 204 and 206 are received within slots 128 of an upper container 200. Angled side walls 204 and 206, angled end walls 208 and 210, and stacking tabs 138 and 148 provide four-way stacking support for upper containers 200 stacked on a lower container 200. Additionally, angled side walls 204 and 206, angled end walls 208 and 210, and stacking tabs 138 and 148 prevent an upper container 200 from falling or sliding into a lower container 200.

As described in more detail below, the layout and configuration of blank 100 reduces the overall footprint of blank 100 relative to conventional blanks that employ rollover panels for structural stability. In at least some cases, the reduced footprint of blank 100 results in a reduction in the amount of raw material needed to fabricate blank 100 compared to conventional blanks.

FIG. 4 is a top plan view of a conventional blank 400 used to form a stackable container. Conventional blank 400 includes rollover panels 402 to provide structural stability for stacking a plurality of containers formed from blank 400. The opposing edges of rollover panels 402 define the width W₄₀₀ of conventional blank 400. Because of the additional rollover panels 402, the width W₄₀₀ of conventional blank 400 is greater than the width W₁₀₀ of blank 100. The conventional blank 400 shown in FIG. 4 has a width of about 33.75 inches or 832 mm. Each rollover panel 402 of the conventional blank 400 includes gusset panels 404 and second interior end panels 406, which partially form corner walls when blank is articulated to form a container.

In contrast to conventional blank 400, blank 100 employs stacking tabs 138 and 148, tapered fold lines 134, and tapered edges 144 of interior end panels 132, which provide four-way structural support for stacking a plurality of containers 200 formed from blank 100. In addition, blank 100 includes double-wall corrugated paperboard to provide additional stacking support, as described in more detail below. As a result, rollover panels 402 of conventional blank 400 are not needed for container 200, wherein container 200 has improved stacking strength over containers formed from conventional blank 400. Thus, the overall footprint of blank 100 is reduced compared to conventional blank 400. In at least some cases, the reduced footprint of blank 100 results in a reduction in the amount of raw material needed to fabricate blank 100. Additionally, because blank 100 does not include gusset panels 404 or second interior end panels 406, no internal corner walls are formed within container 200 when blank 100 is articulated. As a result, the cavity 212 within container 200 has more space available to hold goods or other materials, and is better able to receive square or rectangular shaped cartons or boxes arranged within cavity 212. Further, because the overall width W₁₀₀ of blank 100 is reduced compared to conventional blank 400, the total amount of waste material produced during fabrication of blank 100 is reduced, and the throughput of blanks 100 is increased, as described in more detail below.

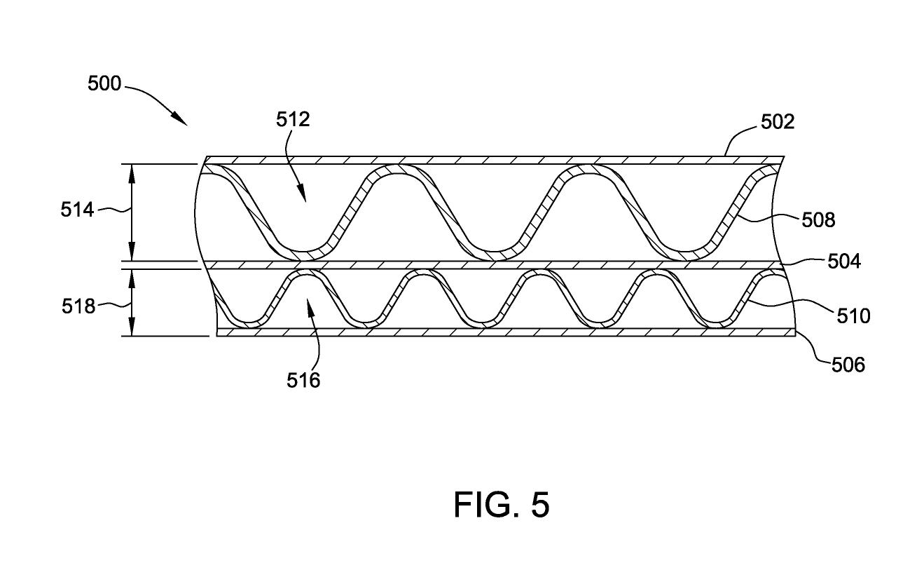

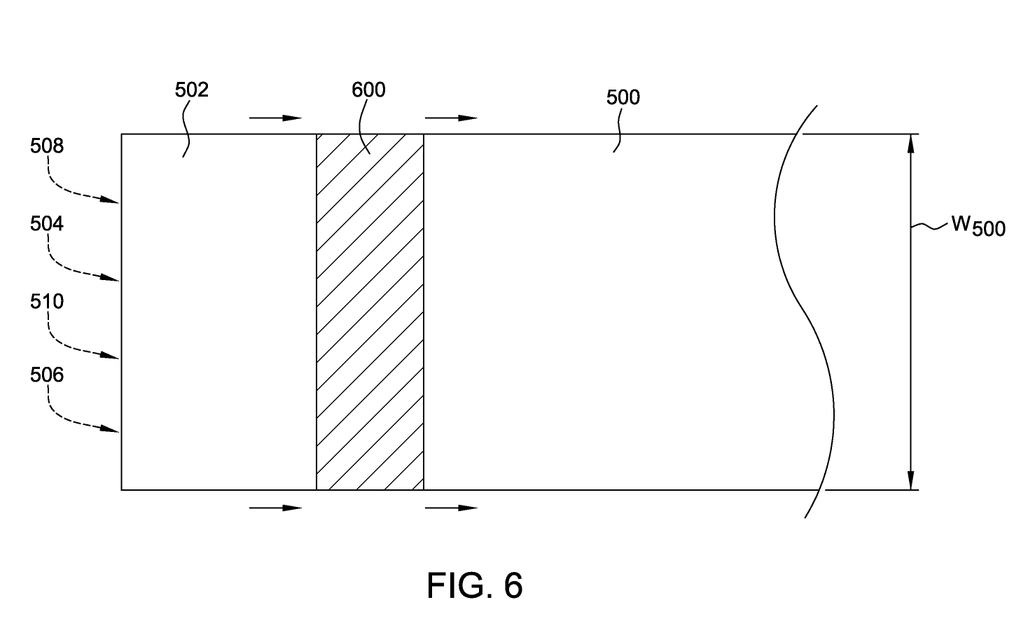

Referring now to FIG. 5, in one embodiment, blank 100 is fabricated from a sheet of double-wall corrugated paperboard 500. FIG. 5 is a partial cross sectional view of double-wall corrugated paperboard 500. Double-wall corrugated paperboard 500 comprises three liners and two mediums: inner liner 502, middle liner 504 and outer liner 506; and inner medium 508, and outer medium 510. Inner liner 502 corresponds to the interior surface 102 of formed blank 100, and outer liner 506 corresponds to the exterior surface 104 of formed blank 100. Liners 502, 504, and 506, and mediums 508 and 510 are laminated together to form the sheet of double-wall corrugated paperboard 500 using a corrugator machine, such as the corrugator machine 600 illustrated in FIG. 6. A plurality of inner flutes 512 having a thickness 514 are formed by the inner liner 502, the inner medium 508, and the middle liner 504. A plurality of outer flutes 516 having a thickness 518 is formed by the middle liner 504, the outer medium 510, and the outer liner 506. In the embodiment shown in FIG. 1, flutes 512 and 516 are oriented such that the flutes 512 and 516 extend from first edge 106 to second edge 108. Flutes 512 and 516 provide structural integrity for the paperboard, and the blanks and containers formed therefrom. In the embodiment shown in FIG. 5, the thickness 514 of inner flutes 512 is greater than the thickness 518 of the outer flutes 518, and, more specifically, is between about one to two times greater, and, even more specifically, is about one and one-half times greater than the thickness 518 of the outer flutes 516. In one particular embodiment, the thickness 514 of the inner flutes is about 3/16 inches (4.8 mm) and the thickness 518 of the outer flutes 516 is about ⅛ inches (3.2 mm) This particular type of double-wall corrugated paper board is also known as “B/A” double-wall corrugated paperboard, where “B” refers to the flute type of the outer flutes 516, and “A” refers to the flute type of the inner flutes 512. Table 1 lists properties of particular flute types commonly denoted with the letters A, B, C, E, and F. In other particular embodiments, double-wall corrugated paperboard 500 may have a “B/C” double-wall configuration or any other suitable configuration that enables the blank 100 to function as described herein.

TABLE 1

| | | Flute | | Flute |
|---|---|---|---|---|
| | Flutes per | thickness | Flutes per | thickness |
| Flute Type | linear foot | (in) | linear meter | (mm) |
| A | 33 +/− 3 | 3/16 | 108 +/− 10 | 4.8 |
| B | 47 +/− 3 | ⅛ | 154 +/− 10 | 3.2 |
| C | 39 +/− 3 | 5/32 | 128 +/− 10 | 4.0 |
| E | 90 +/− 4 | 1/16 | 295 +/− 13 | 1.6 |
| F | 128 +/− 4 | 1/32 | 420 +/− 13 | 0.8 |

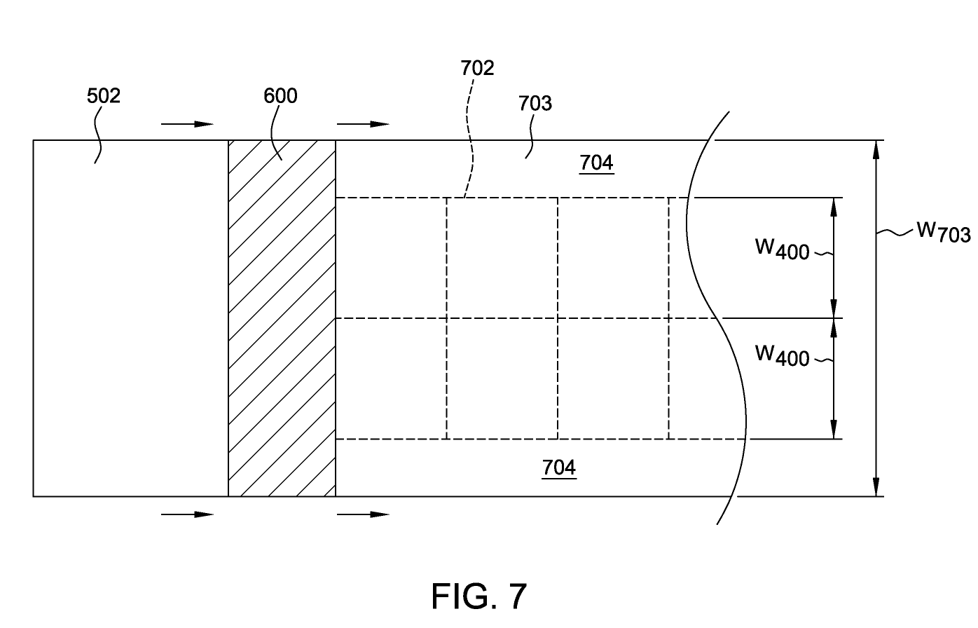

FIG. 6 is a top view of a schematic illustration of a corrugator machine 600 used to fabricate sheets of double-wall corrugated paperboard 500. Corrugator machine 600 may be configured to also produce sheets of single-wall corrugated paperboard 703 (shown in FIG. 7). To fabricate sheets of double-wall corrugated paperboard 500, unlaminated liners 502, 504, and 506, and mediums 508 and 510 are fed into corrugator machine 600 in the direction indicated by the arrows in FIG. 6. Corrugator machine 600 laminates liners 502, 504, and 506, and mediums 508 and 510 to form a sheet 500 of double-wall corrugated paperboard having a width W₅₀₀. Generally, corrugator machine 600 is only capable of producing sheets 500 of corrugated paperboard having a fixed width W₅₀₀. In other words, corrugator machine 600 cannot be adjusted to produce sheets of corrugated paperboard having different widths. As a result, the maximum number of blanks that can be fabricated from a single width of sheet 500 depends on the width of the blank layout. In the embodiment shown in FIG. 6, the corrugator machine 600 is a standard 98 inch corrugator machine commonly used in the paperboard industry to produce corrugated sheets having a width of about 98 inches (2482.2 millimeters).

FIG. 7 is a top view of the corrugator machine 600 (illustrated in FIG. 6) showing a blank layout pattern 702 of conventional blank 400 on a sheet 703 of corrugated paperboard having an overall width W₇₀₃ similar to sheet 500. Sheet 703 may be a single-wall or double-wall corrugated sheet, although conventional blanks 400 fabricated from single-wall corrugated paperboard may lack sufficient stacking strength for certain applications of containers formed from conventional blanks 400. As shown in FIG. 7, the maximum number of blanks 400 that can be fabricated from a single width of sheet 703 is two. The unusable portions 704 of sheet 703 may be recycled using a paper pulper device (also known as a repulper) (not shown). However, because of the energy lost in fabricating and recycling unusable portions 704, as well as material lost in the recycling process, unusable portions 704 represent a considerable amount of waste material.

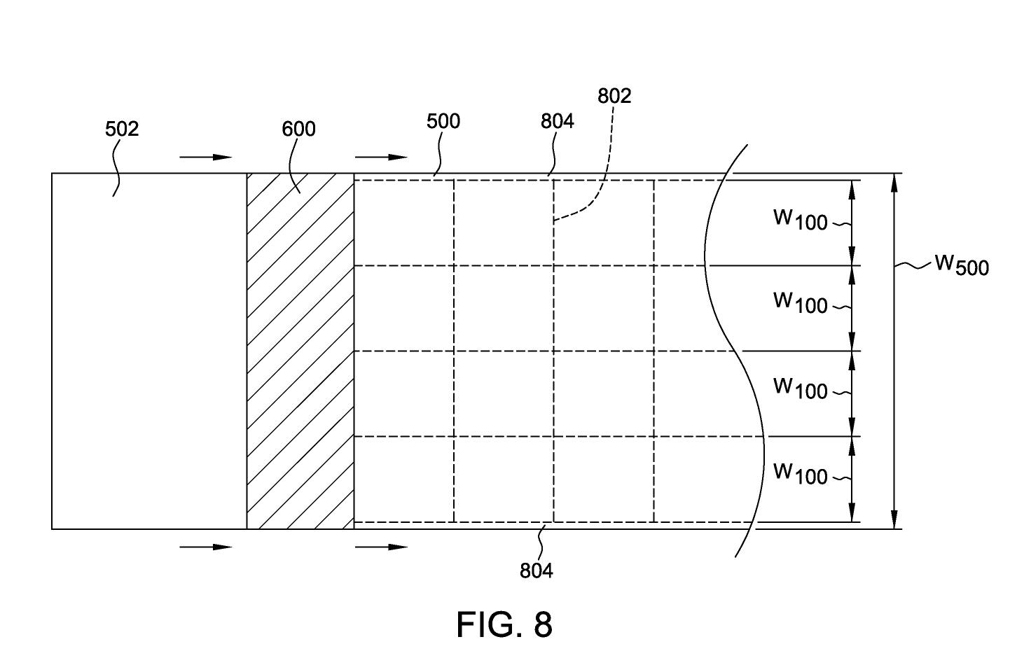

FIG. 8 is a top view of the corrugator machine 600 (illustrated in FIG. 6) showing a blank layout pattern 802 of blank 100 on a double-wall sheet 500 of corrugated paperboard. As shown in FIG. 8, the reduced width of blank 100 compared to conventional blank 400 facilitates more efficient use of the double-wall corrugated sheet 500. Up to four blanks 100 may be fabricated from a single width of sheet 500. Additionally, the total square footage of the unusable portions 804 of sheet 500 is significantly reduced. As a result, the total amount of waste material produced during fabrication of blank 100 is reduced. Additionally, the number of blanks 100 that can be produced in a given amount of time is increased, thereby increasing the potential throughput of blanks 100.

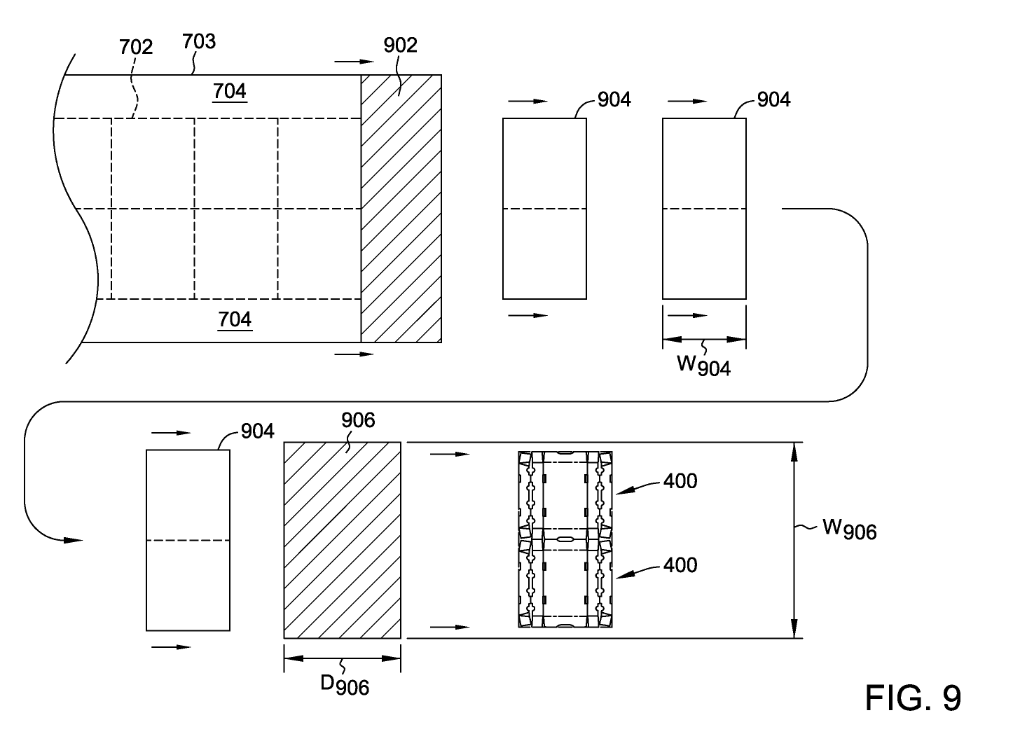

FIG. 9 is a schematic illustration of the process of fabricating conventional blanks 400. Sheets 703 of corrugated paperboard are fed through a converter 902 which cuts the sheet 703 into one or more sheets 904 having a desired width W₉₀₄. The width W₉₀₄ of sheet 904 used to fabricate conventional blank 400 is slightly larger than the width W₄₀₀ of a single conventional blank 400 in order to provide a sufficient amount of trim as sheet 904 passes through die cutter 906. The sheet 904 shown in FIG. 9 has a width W₉₀₄ of about 34 inches (864 mm) Sheets 904 are then aligned with and fed through a cylindrical die cutter 906 having a fixed diameter D₉₀₆. Die cutter 906 includes a plurality of cutting members (not shown) arranged in a predetermined pattern on a peripheral surface of die cutter 906. As sheets 904 are fed through die cutter 906, die cutter 906 rotates about its longitudinal axis causing cutting members to cut and perforate sheets 904 according to the predetermined pattern, thereby forming blanks 400. As shown in FIG. 9, the die cutter and cutting elements may be configured to form more than one blank upon a single rotation of die cutter 906.

The throughput of blanks is in part a function of the diameter of die cutter 906. However, the diameter D₉₀₆ of die cutter 906 can only be increased to a certain point before the size and/or mass of die cutter 906 becomes too great to be used with existing equipment and machinery used to produce paperboard blanks. In the embodiment shown in FIG. 9, the die cutter 906 has a diameter of about 21 inches (533 mm), and a circumference of about 66 inches (1676.4 mm), although die cutters having other diameters and circumferences may be used without departing from the scope of the present disclosure.

As shown in FIG. 9, the width of sheet 904 only permits one conventional blank 400 to be fabricated along a single width of sheet 904 using die cutter 906. Additionally, because fabrication of conventional blank 400 generates a significant amount of scrap material compared to blank 100, the number of conventional blanks 400 that can be fabricated along the width of die cutter 906 is limited. In the example shown in FIG. 9, only two conventional blanks 400 can be fabricated along the width of die cutter 906.

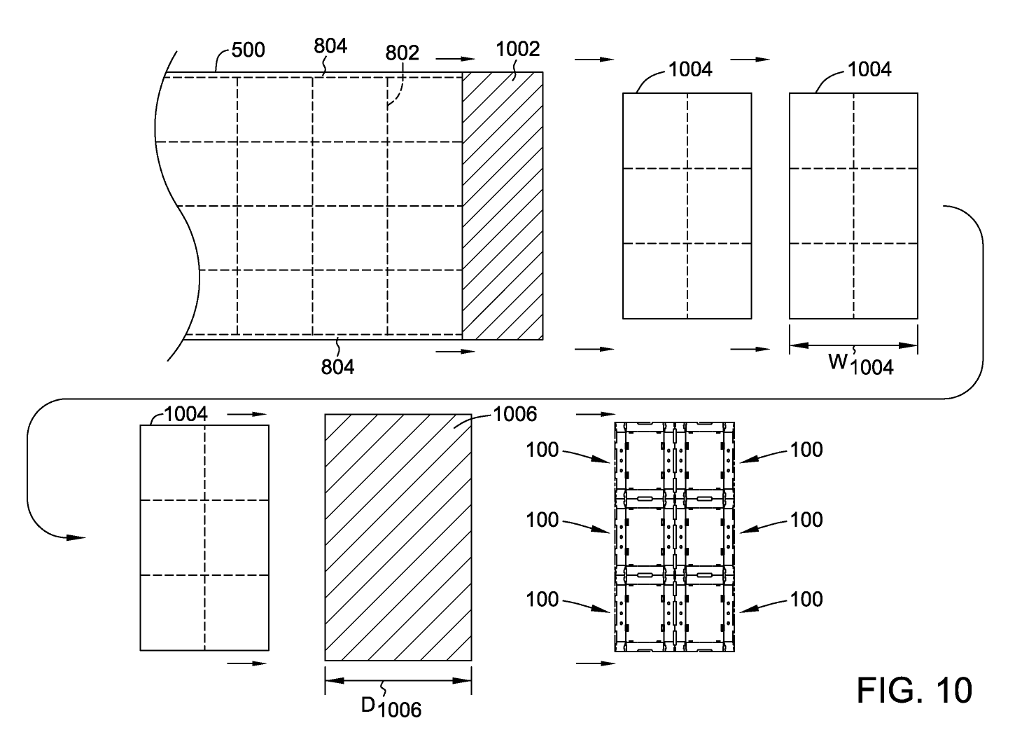

FIG. 10 is a schematic illustration of the process of fabricating blanks 100. Sheets 500 of double-wall corrugated paperboard are fed through a converter 1002 which cuts the sheet 500 into one or more sheets 1004 having a desired width W₁₀₀₄. As described in more detail below, the reduced width W₁₀₀ of blank 100 permits two blanks 100 to be fabricated across a single width of sheet 1004. Accordingly, the width W₁₀₀₄ of sheet 1004 used to fabricate blank 100 is slightly larger than the width W₁₀₀ of two blanks 100 in order to provide a sufficient amount of trim as sheet 1004 passes through die cutter 1006. In the embodiment shown in FIG. 10, the sheet 1004 has a width W₁₀₀₄ of about 48.7 inches (1236 mm) The sheets 1004 are then aligned with and fed through a cylindrical die cutter 1006 having a fixed diameter D₁₀₀₆ similar to fixed diameter D₉₀₆ of die cutter 906. The converter 1002 and die cutter 1006 used to fabricate blanks 100 may be substantially similar to the converter 902 and die cutter 906 used to fabricate conventional blanks 400, with the exception of the arrangement of cutting members disposed on the peripheral surface of die cutter 1006. As shown in FIG. 10, the reduced width of blank 100 compared to conventional blank 400 facilitates improved throughput of blanks 100. Two blanks 100 can be fabricated along a single width W₁₀₀₄ of sheet 1004 using a die cutter 1006 having a similar diameter to die cutter 906. Additionally, because less scrap material is generated during fabrication of blanks 100, more blanks 100 can be fabricated along the width of die cutter 1006. In the embodiment shown in FIG. 10, up to three blanks 100 can be fabricated along the width of die cutter 1006. As a result, a total of up to six blanks 100 can be fabricated upon a single revolution of die cutter 1006. Thus, the throughput of blanks 100 is increased compared to conventional blanks 400 as a result of the layout and configuration of blank 100.

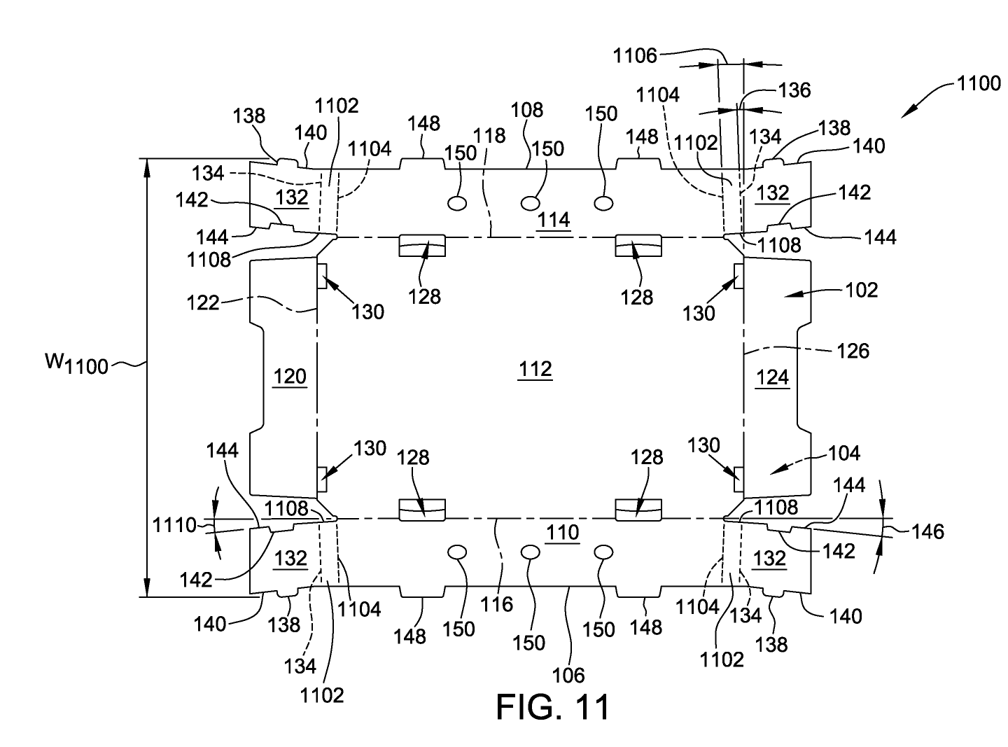

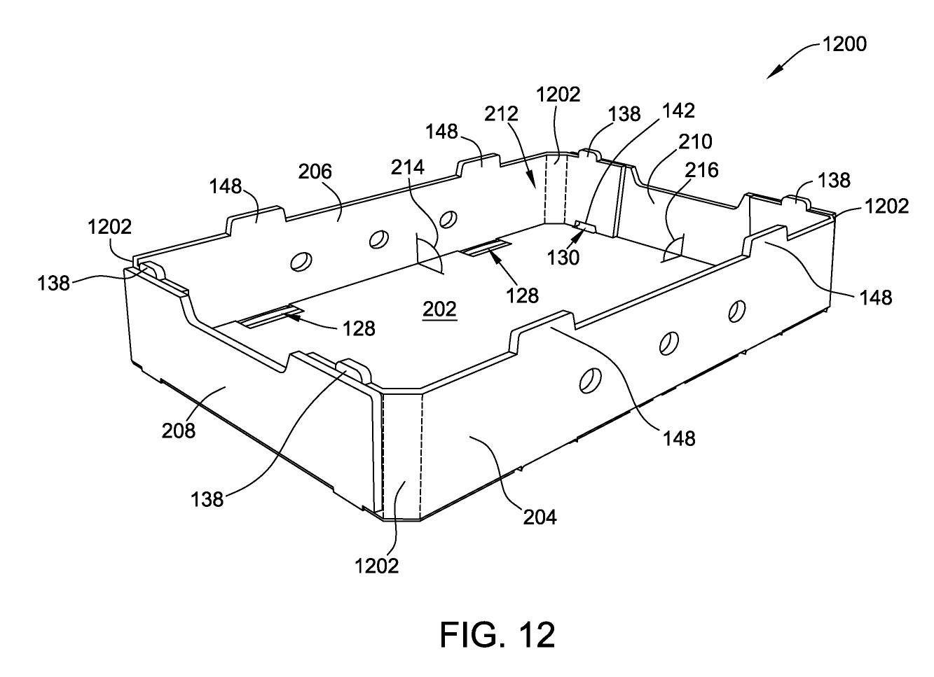

FIG. 11 is a top plan view of an alternative blank 1100 of sheet material for forming a polygonal container. Blank 1100 is substantially similar to blank 100 (shown in FIG. 1), except blank 1100 includes a plurality of miter panels 1102. As such, components shown in FIG. 11 are labeled with the same reference symbols used in FIG. 1. New components are labeled with new reference symbols. Blank 1100 includes miter panels 1102 extending from each side edge of each side panel 110 and 114. As such, blank 1100 includes four miter panels 1102. Each miter panel 1102 extends from respective outer side panel 110 or 114 at a fold line 1104. Each miter panel 1102 is interposed between an interior end panel 132 and one of side panels 110 and 114. Each interior end panel 132 extends from a miter panel 1102 at fold line 134. Similar to fold lines 134, in one embodiment, each fold line 1104 is tapered at an angle 1106 of less than about five degrees, and, more specifically, between about zero degrees and about three degrees, and, even more specifically, about one degree with respect to fold lines 122 and 126. As a result, end walls 208 and 210 of formed container 1200 (shown in FIG. 12) are angled inwardly when blank 1100 is articulated to form container 1200. As described above, the inward angle of end walls 208 and 210 facilitates stacking a plurality of containers 1200 each formed from blank 1100.

In the embodiment shown in FIG. 11, fold lines 134 and 1104 are substantially parallel. In alternative embodiments, fold lines 1104 may be substantially perpendicular to fold lines 116 and 118, and fold lines 134 may be tapered with respect to fold lines 122 and 126. In such embodiments, fold lines 134 may form an angle of less than about five degrees, and, more specifically, between about zero degrees and about three degrees, and, even more specifically, about one degree with respect to fold lines 1104. As a result, end walls 208 and 210 of formed container (shown in FIG. 12) are angled inwardly when blank 1100 is articulated to form container 1200. As described above, the inward angle of end walls 208 and 210 facilitates stacking a plurality of containers 1200 each formed from blank 1100. In another alternative embodiment in which fold lines 1104 are substantially perpendicular to fold lines 116 and 118, however, at least one fold line 134 is not tapered with respect to a corresponding one of fold line 122 and 126, such that the at least one fold line 134 forms an angle of zero with respect to a corresponding fold line 1104.

The bottom edge 1108 of each miter panel 1102 is substantially parallel with the bottom edge 144 of each interior end panel 132. Accordingly, in one embodiment, the bottom edge 1108 of each miter panel 1102 is tapered at an angle 1110 of less than about seven degrees, and, more specifically, between about one degree and about five degrees, and, even more specifically, about three degrees with respect to fold lines 116 and 118. As a result, side walls 204 and 206 of formed container 1200 (shown in FIG. 12) are angled inwardly when blank 1100 is articulated to form container 1200. As described above, the inward angle of side walls 204 and 206 facilitates stacking a plurality of containers 1200 each formed from blank 1100. In an alternative embodiment, however, the bottom edge 144 of at least one interior end panel 132 is not tapered, and the bottom edge 1108 of a corresponding one miter panel 1102 also is not tapered, such that angle 1110 is zero.

Similar to blank 100, blank 1100 does not employ rollover panels as used in conventional blanks, such as conventional blank 400. As a result, the overall width W₁₁₀₀ of blank 1100 is reduced compared to conventional blanks. Accordingly, the configuration and layout of blank 1100 achieves substantially the same benefits and advantages as blank 100, described above.

FIG. 12 is a perspective view of an example polygonal container 1200 formed from blank 1100 (shown in FIG. 11). Container 1200 is formed substantially similar to container 200 (shown in FIG. 2), except container 1200 includes a plurality of corner walls 1202. As such, components shown in FIG. 12 are labeled with the same reference symbols used in FIG. 2. New components are labeled with new reference symbols. In the embodiment shown in FIG. 12, each corner wall 1202 extends from one of side walls 204 and 206 to one of end walls 208 and 210. As such, container 1200 includes a total of eight walls, including four corner walls 1202, two side walls 204 and 206, and two end walls 208 and 210. In addition to the benefits described above with reference to blank 100 and container 200, the corner walls 1202 of polygonal container 1200 provide increased stacking strength.

More specifically, in an embodiment, the polygonal container 1200 formed from a blank of sheet material includes the bottom wall 202 and a pair of opposing end walls 208 and 210 coupled to the bottom wall. Each end wall 208 and 210 includes at least one stacking tab 138 extending from a top edge of the respective end wall. The polygonal container 1200 also includes a pair of opposing side walls 204 and 206 coupled to the bottom wall 202. Each side wall 204 and 206 includes at least one stacking tab 148 extending from a top edge of the respective side wall. The polygonal container 1200 further includes the plurality of corner walls 1202 that each extend between one of the side walls 204 and 206 and one of the end walls 208 and 210. In certain embodiments, the bottom wall 202 includes a plurality of slots 128 and/or 130 configured to receive stacking tabs 138 and/or 148 of a formed container 1200, wherein each end wall 208 and 210 and each sidewall 204 and 206 are adjacent to at least one slot of the plurality of slots.

In some embodiments, each end wall 208 and 210 further includes at least one notch 142 extending into the respective end wall from a bottom edge opposite the top edge of the end wall, wherein each notch is aligned with one slot of the plurality of slots. In a particular embodiment, each end wall 208 and 210 includes two notches 142 extending into the respective end wall from a bottom edge opposite the top edge of the end wall. Similarly, in some embodiments, each end wall 208 and 210 includes two stacking tabs 138 extending from a top edge of the respective end wall. In some embodiments, each side wall 204 and 206 includes two stacking tabs 148 extending from a top edge of the respective side wall.

Moreover, in some embodiments, each side wall 204 and 206 forms an angle 214 of less than about 90 degrees with respect to the bottom wall 202. In certain embodiments, each side wall 204 and 206 forms an angle 214 of between about 85 degrees and about 89 degrees with respect to the bottom wall 202. In a particular embodiment, each side wall 204 and 206 forms an angle 214 of about 87 degrees with respect to the bottom wall.

Similarly, in some embodiments, each end wall 208 and 210 forms an angle 216 of less than about 90 degrees with respect to the bottom wall 202. In certain embodiments, each end wall 208 and 210 forms an angle 216 of between about 87 degrees and about 90 degrees with respect to the bottom wall 202. In a particular embodiment, each end wall 208 and 210 forms an angle 216 of about 89 degrees with respect to the bottom wall 202.

Further, in some embodiments, due to a taper of fold lines 1104 and/or a taper of bottom edges 1108 of blank 1100 as described above (shown in FIG. 11), each corner wall 1102 forms an angle of less than about 90 degrees with respect to the bottom wall 202. In certain embodiments, each corner wall 1102 forms an angle of between about 87 degrees and about 90 degrees with respect to the bottom wall 202. In a particular embodiment, each corner wall 1102 forms an angle of about 89 degrees with respect to the bottom wall 202.

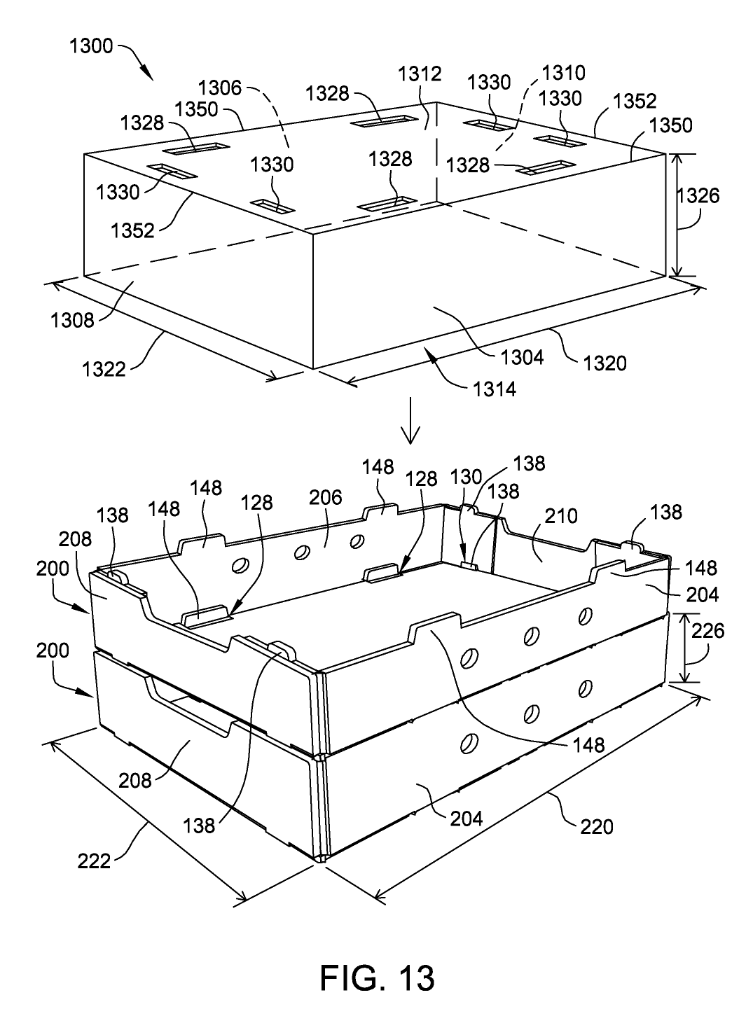

FIG. 13 is a perspective view of an example shipping hood 1300 that may be used with at least one container 200 shown in FIGS. 2 and 3. The shipping hood 1300 includes first and second opposing side walls 1304 and 1306, first and second opposing end walls 1308 and 1310, and a top wall 1312. Each of the side walls 1304 and 1306 and end walls 1308 and 1310 extend generally perpendicularly to the top wall 1312, and each of the side walls 1304 and 1306 is generally perpendicular to each of the end walls 1308 and 1310. The top wall 1312 includes a pair of side edges 1350 adjacent each of side walls 1304 and 1306, and a pair of end edges 1352 adjacent each of end walls 1308 and 1310.

The side walls 1304 and 1306, end walls 1308 and 1310, and top wall 1312 define a cavity 1314 sized to receive at least one container 200 in a clearance fit. Thus, a side length 1320 of the shipping hood 1300 is slightly larger than a side length 220 of the container 200, and an end width 1322 of the shipping hood 1300 is slightly larger than an end width 222 of the container 200. In addition, a height 1326 of the shipping hood 1300 is approximately equal to an integer multiple of a height 226 of the container 200 as measured without regard to the stacking tabs 138 and 148. For example, in the illustrated embodiment, the shipping hood 1300 is configured to receive two stacked containers 200, and thus the shipping hood height 1326 is approximately twice the container height 226. In an alternative embodiment, the shipping hood 1300 is configured to receive three stacked containers 200, and the shipping hood height 1326 is approximately three times the container height 226. The shipping hood 1300 may be configured to receive any number of stacked containers 200, or to receive a single container 200.

In the illustrated embodiment, a plurality of slots 1328 and 1330 are defined at least partially in the top wall 1312 of the shipping hood 1300. Each of slots 1328 is configured to receive a stacking tab 148 from an uppermost stacked container 200 received in cavity 1314, and each of slots 1330 is configured to receive a stacking tab 138 from the uppermost stacked container 200 received in cavity 1314. Each slot 1328 is adjacent to a side edge 1350 of top wall 1312, and each slot 1330 is adjacent to an end edge 1352 of top wall 1312. Moreover, in certain embodiments, a spacing of each slot 1328 from the adjacent side edge 1350 is determined based on the angle 214 (shown in FIG. 2) of the container side wall 206. For example, in an embodiment, the angle 214 is 87 degrees, and each slot 1328 is spaced slightly inward on the top wall 1312 from the adjacent side edge 1350 to accommodate a corresponding inward position of tab 148 relative to the side edge 1350. In an alternative embodiment, for example, the angle 214 is 90 degrees, and each slot 1328 is positioned on the adjacent side edge 1350.

Similarly, in certain embodiments, a spacing of each slot 1330 from the adjacent end edge 1352 is determined based on the angle 216 (shown in FIG. 2) of the container side wall 206. For example, in an embodiment, the angle 216 is 89 degrees, and each slot 1330 is spaced slightly inward on the top wall 1312 from the adjacent end edge 1352 to accommodate a corresponding inward position of tab 138 relative to the end edge 1352. In an alternative embodiment, for example, the angle 216 is 90 degrees, and each slot 1330 is positioned on the adjacent end edge 1352. In other alternative embodiments, however, the top wall 1312 does not include slots 1328 and slots 1330, and the height 1326 of the shipping hood 1300 is increased to accommodate a height of the tabs 138 and 148 of the uppermost stacked container 200 under the top wall 1312.

In an embodiment, the shipping hood 1300 is formed from a blank fabricated from one of a corrugated cardboard material, cardboard, plastic, fiberboard, paperboard, foamboard, corrugated paper, and/or any suitable material. In an embodiment, shipping hood 1300 is coupled to a stack of received containers 200 by coupling shipping hood 1300 to the bottommost container 200 using, for example, tape. In alternative embodiments, shipping hood 1300 is coupled to the stack of received containers 200 in any suitable fashion. The shipping hood 1300 facilitates protecting the contents of each stacked container 200 during shipping, and also may provide stacking strength in addition to that provided by embodiments of the container 200.

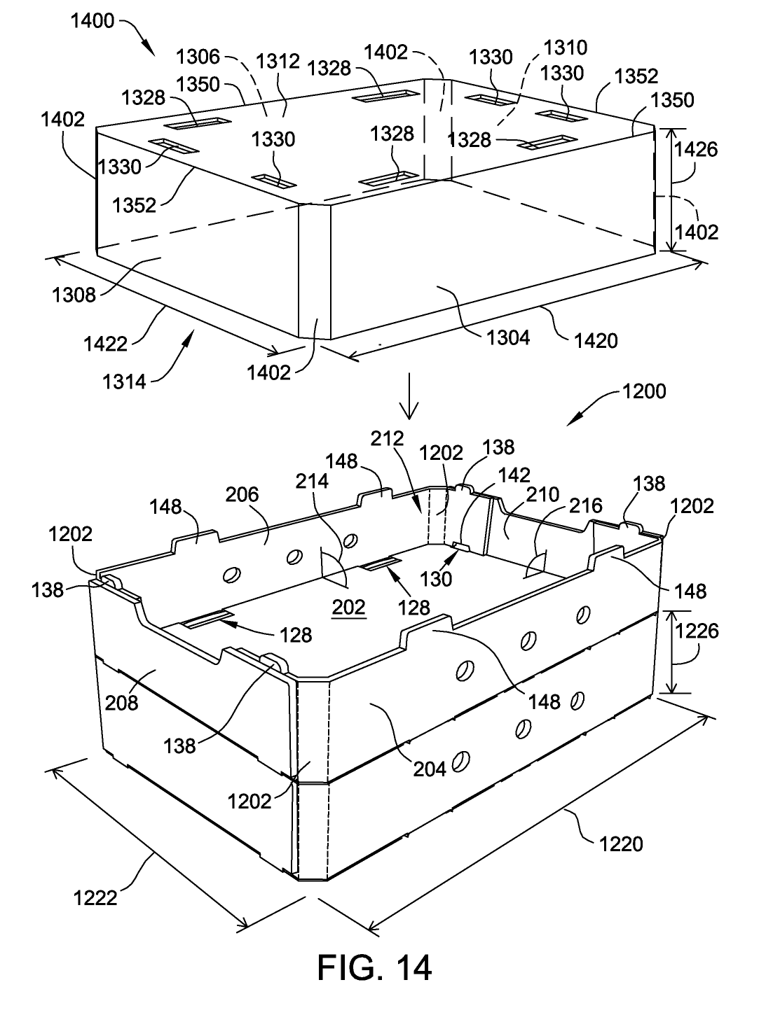

FIG. 14 is a perspective view of an example shipping hood 1400 that may be used with at least one container 1200 shown in FIG. 12. Shipping hood 1400 is formed substantially similar to shipping hood 1300 (shown in FIG. 13), except shipping hood 1400 includes a plurality of corner walls 1402. As such, components shown in FIG. 14 are labeled with the same reference symbols used in FIG. 13. New components are labeled with new reference symbols.

Similarly to shipping hood 1300, the side walls 1304 and 1306, end walls 1308 and 1310, and top wall 1312 of the shipping hood 1400 define a cavity 1314 sized to receive at least one container 1200 in a clearance fit. Thus, a side length 1420 of the shipping hood 1400 is slightly larger than a side length 1220 of the container 1200, and an end width 1422 of the shipping hood 1400 is slightly larger than an end width 1222 of the container 1200. In addition, a height 1426 of the shipping hood 1400 is approximately equal to an integer multiple of a height 1226 of the container 1200 as measured without regard to the stacking tabs 138 and 148. For example, in the illustrated embodiment, the shipping hood 1400 is configured to receive two stacked containers 1200, and thus the shipping hood height 1426 is approximately twice the container height 1226. Also, in certain embodiments of shipping hood 1400, a spacing of each slot 1328 from the adjacent side edge 1350 is determined based on the angle 214 (shown in FIG. 12) of the container side wall 206, and a spacing of each slot 1330 from the adjacent end edge 1352 is determined based on the angle 216 (shown in FIG. 12) of the container side wall 206, as described above for shipping hood 1300.

In an embodiment, the shipping hood 1400 is formed from a blank fabricated from one of a corrugated cardboard material, cardboard, plastic, fiberboard, paperboard, foamboard, corrugated paper, and/or any suitable material. In an embodiment, shipping hood 1400 is coupled to a stack of received containers 1200 by coupling shipping hood 1400 to the bottommost container 1200 using, for example, tape. In alternative embodiments, shipping hood 1400 is coupled to the stack of received containers 1200 in any suitable fashion. The shipping hood 1400 facilitates protecting the contents of each stacked container 1200 during shipping, and also may provide stacking strength in addition to that provided by embodiments of the container 1200.

Example embodiments of polygonal containers and blanks for making the same are described above in detail. The containers and blanks are not limited to the specific embodiments described herein, but rather, components of the blanks and/or the containers may be utilized independently and separately from other components described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A blank of sheet material for forming a polygonal container, the blank comprising:
a bottom panel comprising a plurality of slots configured to receive stacking tabs of a formed container;
two opposing end panels, each end panel extending from opposing end edges of the bottom panel;
two opposing side panels, each side panel extending from opposing side edges of the bottom panel, wherein each side panel comprises at least one stacking tab extending from a top edge of the side panel;
interior end panels foldably connected to each side edge of each side panel along a first fold line, wherein each interior end panel comprises at least one stacking tab extending from a first edge of the respective interior end panel.

2. A blank in accordance with claim 1, wherein each interior end panel further comprises at least one notch extending into the respective interior end panel from a second edge opposite the first edge, wherein each notch is aligned with one the plurality of slots of the bottom panel upon articulation of the blank.

3. A blank in accordance with claim 1, wherein each interior end panel includes a second edge opposite the first edge, and each second edge is tapered at an angle of less than seven degrees with respect to a side edge of the bottom panel.

4. A blank in accordance with claim 3, wherein the second edge of each interior end panel is tapered at an angle of between about one degree and about five degrees with respect to the side edge of the bottom panel.

5. A blank in accordance with claim 4, wherein the second edge of each interior end panel is tapered at an angle of about three degrees with respect to the side edge of the bottom panel.

6. A blank in accordance with claim 1, wherein each first fold line is tapered at an angle of less than five degrees with respect to an end edge of the bottom panel.

7. A blank in accordance with claim 6, wherein each first fold line is tapered at an angle of between about zero degrees and about three degrees with respect to the end edge of the bottom panel.

8. A blank in accordance with claim 7, wherein each first fold line is tapered at an angle of about one degree with respect to the end edge of the bottom panel.

9. A blank in accordance with claim 1, wherein each side panel comprises two stacking tabs.

10. A blank in accordance with claim 1, wherein the blank is formed from a double-wall corrugated paper material comprising:
a first liner;
a second liner;
a third liner;
a first medium disposed between the first liner and the second liner, said first medium defining a first plurality of flutes having a first thickness; and
a second medium disposed between the second liner and the third liner, said second medium defining a second plurality of flutes having a second thickness, wherein the first thickness is greater than the second thickness.

11. A blank in accordance with claim 10, wherein the first thickness of the first plurality of flutes is about one and one-half times greater than the second thickness of the second plurality of flutes.

12. A blank in accordance with claim 11, wherein the first thickness of the first plurality of flutes is about ⅛ of an inch and the second thickness of the second plurality of flutes is about 3/16 of an inch.

13. A polygonal container formed from a blank of sheet material, the container comprising:
a bottom wall;
a pair of opposing end walls coupled to the bottom wall, each end wall comprising at least one stacking tab extending from a top edge of the respective end wall; and
a pair of opposing side walls coupled to the bottom wall, each side wall comprising at least one stacking tab extending from a top edge of the side wall.

14. A container in accordance with claim 13, wherein the bottom wall comprises a plurality of slots configured to receive stacking tabs of a formed container, wherein each end wall and each sidewall are adjacent to at least one slot of the plurality of slots.

15. A container in accordance with claim 14, wherein each end wall further comprises at least one notch extending into the respective end wall from a bottom edge opposite the top edge of the end wall, wherein each notch is aligned with one slot of the plurality of slots.

16. A container in accordance with claim 15, wherein each end wall comprises two notches extending into the respective end wall from a bottom edge opposite the top edge of the end wall.

17. A container in accordance with claim 13, wherein each side wall forms an angle of less than about 90 degrees with respect to the bottom wall.

18. A container in accordance with claim 17, wherein each side wall forms an angle of about 87 degrees with respect to the bottom wall.

19. A container in accordance with claim 13, wherein each end wall forms an angle of less than about 90 degrees with respect to the bottom wall.

20. A container in accordance with claim 19, wherein each end wall forms an angle of about 89 degrees with respect to the bottom wall.

21. A container in accordance with claim 13, further comprising a plurality of corner walls extending between each side wall and each end wall.

22. A container in accordance with claim 15, wherein each corner wall forms an angle of less than about 90 degrees with respect to the bottom wall.

23. A container in accordance with claim 13, wherein each end wall comprises two stacking tabs extending from a top edge of the respective end wall.

24. A container in accordance with claim 13, wherein each side wall comprises two stacking tabs extending from a top edge of the respective side wall.

25. A method of forming a polygonal container from a blank of sheet material, the blank including a bottom panel, two opposing end panels, each end panel extending from opposing end edges of the bottom panel, two opposing side panels, each side panel extending from opposing side edges of the bottom panel, wherein each side panel includes at least one stacking tab extending from a top edge of the side panel, and interior end panels foldably connected to each side edge of each side panel along a first fold line, wherein each interior end panel includes at least one stacking tab extending from a first edge of the respective interior end panel, the method comprising:
rotating each side panel towards an interior surface of the bottom panel such that each side panel forms an angle of less than about 90 degrees with respect to the bottom panel, wherein the side panels define opposing side walls;
rotating each interior end panel about the first fold line such that each interior end panel is substantially perpendicular to a respective side panel;
rotating each end panel towards an exterior surface of the interior end panels such that each end panel forms an angle of less than about 90 degrees with respect to the bottom panel; and
coupling each end panel to the exterior surfaces of two interior end panels to form two opposing end walls.

26. A method in accordance with claim 25, wherein rotating each side panel comprises rotating each side panel towards an interior surface of the bottom panel such that each side panel forms an angle of between about 85 degrees and about 89 degrees with respect to the bottom panel.

27. A method in accordance with claim 25, wherein rotating each end panel comprises rotating each end panel towards an exterior surface of the interior end panels such that each end panel forms an angle of between about 87 degrees and about 90 degrees with respect to the bottom panel.

28. A method in accordance with claim 25, wherein the blank further includes a plurality of miter panels foldably connected to each side edge of each side panel along a second fold line, each interior end panel is foldably connected to a corresponding one of the miter panels along the first fold line, the method further comprising rotating each miter panel about the second fold line towards an interior surface of the connected side panel.

29. A method in accordance with claim 28, wherein rotating each miter panel about the second fold line further comprises rotating each miter panel such that the miter panel forms an angle of less than about 90 degrees with respect to the bottom panel.

30. A shipping system for a polygonal container formed from a blank of sheet material, the shipping system comprising:
at least one container comprising:
a bottom wall;
a pair of opposing end walls coupled to the bottom wall, each end wall comprising at least one stacking tab extending from a top edge of the respective end wall; and
a pair of opposing side walls coupled to the bottom wall, each side wall comprising at least one stacking tab extending from a top edge of the side wall; and
a shipping hood comprising a top wall, a pair of opposing end walls coupled to the top wall at a respective pair of end edges, a pair of opposing side walls coupled to the top wall at a pair of respective side edges, and a cavity defined by the pair of opposing end walls, the pair of opposing side walls, and the top wall, wherein the cavity is configured to receive the at least one container, and wherein the top wall comprises:
at least one slot adjacent each of the pair of end edges and configured to receive the at least one stacking tab that extends from the top edge of the respective end wall of the at least one container; and
at least one slot adjacent each of the pair of side edges and configured to receive the at least one stacking tab that extends from the top edge of the respective side wall.
